(19) United States
(12) Patent Application Publication
(10) Pub. No.: US 2003/0196664 A1
(43) Pub. Date: Oct. 23, 2003

(54) Inhalation face mask

(76) Inventor: Maria Jacobson, Weston, FL (US)

Correspondence Address: John Christopher, Christopher & Weisberg, P.A., Suite 2040, 200 East Las Olas Boulevard, Fort Lauderdale, FL, 33301, US

(21) Appl. No.: 10/125,116

(22) Filed: Apr. 18, 2002

(51) Int. Cl. A62B 18/08

(52) U.S. Cl. 128/206.21; 128/206.24

(57) ABSTRACT

An inhalation breathing apparatus is provided for administering a respirable fluid. The apparatus is a non-rebreathing face mask, conformable to the contours of an individual's face to enclose the nasal and oral cavities, and includes a source lumen for supplying a respirable fluid, a one-way valve to vent respirated fluid, a reservoir bag coupled to the source lumen and having a one-way valve allowing flow out of the bag and into the mask, and a substantially complaint tubular outer ring disposed on the lip of the mask. The outer ring may be fluid filled and provides a tight fluid seal around the nose and mouth, to prevent the entrainment of room air during administration of respirable fluids such as gaseous oxygen. The body of the mask may also include a number of small openings to allow for the flow of room air into the mask in the event of malfunction.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

This invention relates to an inhalation breathing apparatus, and, in particular, to non-rebreathing medical face masks.

### BACKGROUND OF THE INVENTION

Inhalation apparatus and systems for administering a respirable fluid to an individual are well-known in the art. Examples of such an apparatus are those used in the medical or dental field for dispensing anaesthetic gases or oxygen to a patient. A particular application for such gas masks are those used to administer oxygen to an individual under a variety of circumstances, such as high altitude emergency masks used in aircraft, or for the customary clinical and hospital purposes.

Certain types of such masks commonly contain a one one-way valve or vent to allow for exhaled gases to exit the patient's body through an opening in the mask, but allowing other fluids surrounding the patient and mask (such as room air) to enter through the mask. Such masks are usually referred to as a “non-rebreathing” mask.

The effectiveness of such a mask however is dictated by its ability to deliver the desired gas to a patient, at a minimum required flow rate, pressure and gas concentration. In order, for example, to deliver oxygen to a patient, the mask must adequately deliver a minimum concentration of oxygen gas through the mask. Often, the types of non-rebreathing masks used in the aforementioned situations do not properly fit around the nose and oral cavity of a patient. As a result, the masks do not form an airtight seal with the patient's face. When high concentration oxygen (of up to 100% oxygen) is thus delivered through the mask, room air (having an oxygen concentration of about 21% or lower) is often entrained through the ill-fitting seal between the mask and the face, thereby diluting the oxygen concentration of the inhaled gas by the patient. Thus, an inhaled oxygen concentration of 100% by volume cannot be obtained with prior known non-rebreathing facemasks.

It would be highly advantageous therefore, to provide a new and improved inhalation apparatus which would effectively deliver a respirable gas without entraining outside gases.

### SUMMARY OF THE INVENTION

An inhalation mask apparatus is disclosed for administering a respirable fluid to an individual having a facial contact surface including a nose and mouth. The apparatus includes a generally concave first body having a lip, an exterior surface and an interior surface, the interior and exterior surfaces being conjoined below the lower lip, the interior surface being disposable against the facial contact surface to cover a portion of the nose and mouth, a source lumen disposed through a first opening through the first body, the source lumen being in fluid communication with a supply of respirable fluid, a one-way valve element disposed through a second opening through the first body, the one-way valve element being adapted to allow fluid to flow from a space adjacent the interior surface to a space adjacent the exterior surface, an oxygen reservoir bag attached to the first body, and a sealing element disposed around the lip in contact with the interior surface.

Alternatively, the body of the inhalation mask apparatus is receivable to conform to the contours of the human face, said body having a source lumen, an exhaust lumen and an interior cavity, a first means for receiving a flow of fluid, said first means being disposed through the source lumen, a second means for exhausting fluid from the interior cavity, and a third means for sealing the interior cavity from external fluid flows, when such body is applied over the nose and mouth of an individual.

The inhalation mask apparatus may also be described as having a substantially concave body element having a perimeter edge and an interior space defined by the body and a substantially planar region, said planar region being coincident with said perimeter edge, a source lumen in fluid communication with a supply of fluid, said interior space being in fluid communication with said source lumen, an exhaust lumen, and a substantially compliant ring of tubing disposed onto the perimeter edge of the body.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a view of a non-rebreathing mask applied to a patient;

FIG. 2 is a view of an exemplary embodiment of the present invention; and

FIG. 3 is a section view of the mask of the present invention, taken along line 3-3 of FIG. 2;

### DETAILED DESCRIPTION OF THE INVENTION

The present invention provides, among other things, a new and improved non-rebreathing mask apparatus for administering or otherwise conducting respirable gas to an individual.

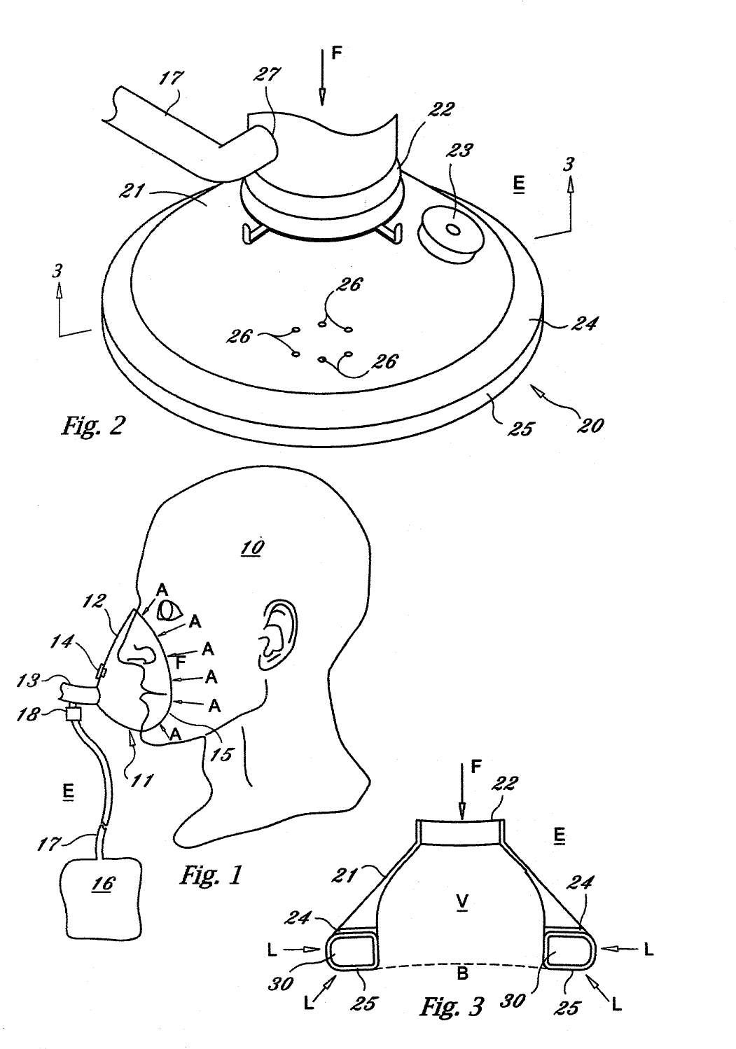

Turning now to the drawings, in which like reference characters indicate like elements in the various views, there is shown in FIG. 1 a typical non-rebreathing gas face mask applied to a patient 10. The mask 11 includes a concave body 12, a gas source lumen 13 attached thereto, and a one-way vent valve 14 disposed through an opening in the body 12. The body 12 also includes a lip 15, which contacts the patient 10 when gas is delivered through the mask 11. The apparatus may further include a gas reservoir bag 16 attached to the gas source lumen 13 via a reservoir line or lumen 17, as shown. The reservoir line may further include a one-way valve 18. As gas is applied through the mask from a gas source (not shown), the gas enters into the cavity formed between the body 12 and the face of the patient 10, and flows in the direction B as the patient 10 inhales the gas. As patient 10 exhales, the respirated gases are vented through the one-way valve 14 out to the surroundings. One-way valve 18 is provided to close during expiration to prevent the flow of respirated gases into reservoir bag 16. Since reservoir bag 16 contains oxygen, it desirable to prevent any dilution of the gases therein via the exhalation of carbon-dioxide rich respirated gas through the device.

Often, due to a poor fit between the patient 10 and the lip 15, outside gases are also entrained into the gas mask via arrows A as shown in FIG. 1. As a result, as a gas is respirated by the individual 10, the flow of supplied gas, shown as F in FIG. 1, is diluted by the entrainment of gases from the environment E. Since the environment is almost always atmospheric air, having an oxygen concentration of only 21% by volume, when oxygen is administered to the patient 10, the relative concentration of oxygen delivered is not at the target level desired.

FIG. 2 shows an exemplary embodiment of a non-rebreathing mask constructed in accordance with the principles of the present invention. A mask 20 includes a concave body 21, a gas source lumen 22, a one-way vent valve 23, an outer lip 24, and a sealing member 25. The mask may also optionally include at least one emergency opening 26, as well as a gas reservoir tube 17 with one-way valve 18 (not shown) attached to a gas reservoir bag (not shown) for feeding gas into the mask via opening 27. FIG. 3 shows a cross section of the mask 20 along lines 3-3 in FIG. 2. As illustrated in FIG. 3, the concave body encloses an interior space or cavity, a volume labeled as region V. When the mask is applied over the facial area of an individual, generally to cover the upper respiratory organs such as the nose and mouth, the interior space or volume V is bounded by the body 21, the specific surface contours of the face, shown schematically in FIG. 3 as line boundary B, and the contact interface between the face and the sealing element 24. As such, the space V is completely isolated from fluid flow or communication with the environment E, provided that the sealing element 24 is relatively airtight as applied to the individual face.

Turning back now to FIG. 2, the mask 20 has a main, cup-like, concave body element 21, well-known to those skilled in the art. The mask 20 may be a non-rebreathing mask, when fitted with a one-way check valve 23 as shown in FIG. 2. The one-way check valve allows fluid to flow only from the interior cavity of the mask 20 (not labeled) out to the environment E. Gases are therefore incapable of being “rebreathed” by the patient. Respirable fluid enters the gas mask apparatus through the source lumen 22 in the direction of the arrow F as shown in FIG. 2. The mask body 21 is bounded at its perimeter edge by a lip element 24. Beneath the lip element is a ring shaped tubular structure 25 adaptable to conform to the contours of the human face. This sealing element 25 is substantially flexible and compliant, and may consist of a substantially toroidal ring of plastic tubing, having a surface adhesion suitable for temporarily adhering, through contact friction only, to the surface of the patient's face. The sealing element may thus squeeze to alter its diameter or shape as needed to provide a tight seal around the nose and mouth of a patient, such that room air from the environment E is not entrained when fluid is supplied through the mask 20 and respired by the patient.

FIG. 3 shows one embodiment of the sealing element 25, wherein the interior of the element is an interior lumen 30. The interior lumen may be filled with room air, or may alternatively be filled with a suitable fluid or even solid, such that the sealing element 25 readily contracts to accommodate any lateral force L as shown in FIG. 3. Thus, when the mask is applied to the face of a patient, the aggregate of forces L generated by the application of the mask against the facial surface contours, acts to push the sealing element 25 into the interior lumen 30, while continually isolating and enclosing the interior volume and cavity V from the environment E. This effectively seals exterior fluids from flowing with the introduced fluid F as the patient inhales through the mask.

Finally, the mask 20 may include a number of emergency openings as shown in FIG. 2, such that surrounding environmental gases such as room air may flow into the mask and be respirable by the patient in the event of malfunction of the apparatus. These openings are generally small compared to the flow lumens 22 and 23 disposed in the mask body, such that even though the openings 26 may allow the interior cavity of the mask 20 to be in fluid communication with the environment E, the flow rates enabled thereby are very small compared with the flow rates of gases inhaled through source lumen 22 and/or exhaust valve 23. Although the openings 26 also provide a means for external gases to enter the interior cavity during application of respirable fluid to the patient, due to the relatively small size of the openings 26, they do not entrain as much air as a typical non-rebreathing face mask not constructed in accordance with the principles of the present invention.

The various components of the mask 20 are constructed from materials generally used in art.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An inhalation mask apparatus for administering a respirable fluid to an individual having a facial contact surface including a nose and mouth, the apparatus further comprising:
a generally concave first body having a lip, an exterior surface and an interior surface, the interior and exterior surfaces being conjoined at the lip, the interior surface being disposable against the facial contact surface to cover a portion of the nose and mouth,
a source lumen disposed through a first opening through the first body, the source lumen being in fluid communication with a supply of respirable fluid,
a first one-way valve element disposed through a second opening through the first body, the one-way valve element being adapted to allow fluid to flow from a space adjacent the interior surface to a space adjacent the exterior surface, and
a sealing element disposed around the lip in contact with the interior surface.

2. The apparatus of claim 1, wherein the sealing element is a substantially compliant tubular cushion, having a ring-like shape, such sealing element being disposed adjacent the lip such that the sealing element circumscribes substantially all of the individual's nose and mouth, when the apparatus is applied against the facial contact area.

3. The apparatus of claim 1, wherein the individual and apparatus are surrounded by a fluid environment, and wherein the sealing element is conformable to the facial contact surface of the individual, such that the interior surface and facial contact surface define an interior space, wherein the interior space is fluidly sealed from the fluid environment.

4. The apparatus of claim 1, wherein the body further comprises at least one opening disposed through such body, such that the interior surface is in fluid communication with an environment external to said body and said interior surface.

5. The apparatus of claim 1, further comprising a fluid reservoir in fluid communication with the source lumen.

6. The apparatus of claim 5, further comprising a reservoir lumen disposed between the fluid reservoir and the source lumen, the reservoir lumen defining a fluid flow path from the fluid reservoir to the source lumen, the reservoir lumen further including a second one-way valve element being adapted to allow fluid to flow from the fluid reservoir to the source lumen, and being adapted to prevent fluid flow from the source lumen to the fluid reservoir.

7. An inhalation mask apparatus having:
a body receivable to conform to the contours of the human face, said body having a source lumen, an exhaust lumen and an interior cavity,
a first means for receiving a flow of fluid, said first means being disposed through the source lumen,
a second means for exhausting fluid from the interior cavity, and
a third means for sealing the interior cavity from external fluid flows, when such body is applied over the nose and mouth of an individual.

8. The apparatus of claim 7, wherein the third means is a substantially compliant tubular cushion disposed on the body.

9. The apparatus of claim 8, wherein the tubular cushion circumscribes the interior cavity.

10. The apparatus of claim 7, further comprising at least one opening through the body, said opening to define a lumen for flow of fluid between the interior cavity and an environment external to said body and said interior cavity.

11. The apparatus of claim 7, further comprising a fluid reservoir in fluid communication with the source lumen.

12. The apparatus of claim 11, further comprising a fourth means to define a fluid flow path from the fluid reservoir to the source lumen, and a fifth means to allow fluid to flow through said flow path from the fluid reservoir to the source lumen, and to prevent fluid flow from the source lumen to the fluid reservoir.

13. An inhalation mask apparatus having:
a substantially concave body element having a perimeter edge and an interior space defined by the body and a substantially planar region, said planar region being coincident with said perimeter edge,
a source lumen in fluid communication with a supply of fluid, said interior space being in fluid communication with said source lumen,
an exhaust lumen, and
a substantially compliant ring of tubing disposed onto the perimeter edge of the body.

14. The apparatus of claim 13, wherein the tubing further comprises a flexible sealing layer, said sealing layer being conformable to the face of an individual.

15. The apparatus of claim 14, wherein the sealing layer encloses an interior lumen disposed inside of the tubing.

16. The apparatus of claim 14, wherein the tubing is filled with air.

17. The apparatus of claim 13, wherein the body further comprises at least one opening disposed through such body, such that the interior space is in fluid communication with an environment external to said body and said interior space.

18. The apparatus of claim 13, further comprising a fluid reservoir in fluid communication with the source lumen.

19. The apparatus of claim 18, further comprising a reservoir lumen disposed between the fluid reservoir and the source lumen, the reservoir lumen defining a fluid flow path from the fluid reservoir to the source lumen, the reservoir lumen further including a one-way valve element being adapted to allow fluid to flow from the fluid reservoir to the source lumen, and being adapted to prevent fluid flow from the source lumen to the fluid reservoir.
